(19) United States
(12) Patent Application Publication
(10) Pub. No.: US 2026/0291051 A1
(43) Pub. Date: Sep. 24, 2026

(54) ANTENNA PACKAGING STRUCTURE

(71) Applicant: AUO Corporation, Hsinchu City (TW)

(72) Inventors: Xiao Yun Li, Hsinchu City (TW); Shuo-Yang Sun, Hsinchu City (TW); Hao-Lun Hsieh, Hsinchu City (TW); Chun Chang, Hsinchu City (TW); Yu-Hao Chang, Hsinchu City (TW); Fu-Yang Chen, Hsinchu City (TW); Jhih-Jhu Jhan, Hsinchu City (TW)

(73) Assignee: AUO Corporation, Hsinchu City (TW)

(21) Appl. No.: 19/369,351

(22) Filed: Oct. 27, 2025

(30) Foreign Application Priority Data
Mar. 19, 2025 (TW) 114110260

(51) Int. Cl. H01Q 1/22; H01Q 1/42

(52) U.S. Cl. CPC H01Q 1/2283; H01Q 1/422

(57) ABSTRACT

An antenna packaging structure includes an electrode layer, a first circuit structure, at least one inorganic dielectric layer, at least one organic dielectric layer, a second circuit structure, and a chip. The first circuit structure is disposed on the electrode layer and includes a conductive layer. The at least one inorganic dielectric layer is disposed between the conductive layer of the first circuit structure and the electrode layer. The electrode layer, the first circuit structure, and the at least one inorganic dielectric layer are disposed on a lower side of the at least one organic dielectric layer. At least one portion of the second circuit structure is disposed on an upper side of the at least one organic dielectric layer. The chip is disposed on the upper side of the at least one organic dielectric layer.

### CROSS-REFERENCE TO RELATED APPLICATION

This application claims the priority benefit of Taiwan application serial no. 114110260, filed on March 19, 2025. The entirety of the above-mentioned patent application is hereby incorporated by reference herein and made a part of this specification.

### BACKGROUND

### Technical Field

The disclosure relates to a packaging structure, and particularly relates to an antenna packaging structure.

### Description of Related Art

In order to reduce the product volume and increase the product value, a redistribution layer process may be used to fabricate an antenna multilayer structure and a chip circuit structure on the antenna multilayer structure. The chip and the chip circuit structure are then bonded together to complete a small-volume antenna packaging structure.

In the process of the conventional antenna packaging structure, a laser drill process may be used to drill through the polyimide (PI) layer of the antenna packaging structure, and a desmear process may be used to clean the drilling. However, the chemical solution used in the desmear process may damage the thin film organic layer located under the polyimide layer. Therefore, it is necessary to form a thin film organic layer with an opening using a photolithography process, so that before forming the polyimide layer, a metal layer may be formed to fill the opening of the thin film organic layer in order to prevent the desmear chemical solution from damaging the thin film organic layer. Therefore, the process of the conventional antenna packaging structure is relatively complex. In addition, the use of stacked organic layers will generate stress changes during the thermal process, making the antenna packaging structure prone to warpage problems.

### SUMMARY

The disclosure provides an antenna packaging structure with a simple process and not prone to excessive warpage.

An antenna packaging structure of the disclosure includes an electrode layer, a first circuit structure, at least one inorganic dielectric layer, at least one organic dielectric layer, a second circuit structure, and a chip. The first circuit structure is disposed on the electrode layer and includes a conductive layer. The at least one inorganic dielectric layer is disposed between the conductive layer of the first circuit structure and the electrode layer. The electrode layer, the first circuit structure, and the at least one inorganic dielectric layer are disposed on a lower side of the at least one organic dielectric layer. At least one portion of the second circuit structure is disposed on an upper side of the at least one organic dielectric layer. The chip is disposed on the upper side of the at least one organic dielectric layer and is connected to the at least one portion of the second circuit structure. The electrode layer has an upper surface and a lower surface opposite to each other and a side surface. The upper surface of the electrode layer is located between the at least one inorganic dielectric layer and the lower surface of the electrode layer. The side surface of the electrode layer is connected to the upper surface of the electrode layer and the lower surface of the electrode layer. An angle θ is included between the side surface of the electrode layer and the lower surface of the electrode layer within a material of the electrode layer. 0°<θ<90°.

### BRIEF DESCRIPTION OF THE DRAWINGS

FIG. 1 is a schematic cross-sectional diagram of an antenna packaging structure according to an embodiment of the disclosure.

FIG. 2A to FIG. 2E are schematic cross-sectional diagrams of a partial manufacturing process of a portion of an antenna packaging structure according to an embodiment of the disclosure.

FIG. 3 is a schematic cross-sectional diagram of an antenna packaging structure according to another embodiment of the disclosure.

FIG. 4 is a schematic cross-sectional diagram of an antenna packaging structure according to another one embodiment of the disclosure.

### DESCRIPTION OF THE EMBODIMENTS

Reference will now be made in detail to the exemplary embodiments of the disclosure, and examples of the exemplary embodiments are illustrated in the accompanying drawings. Whenever possible, the same reference numerals are used in the drawings and description to indicate the same or similar parts.

It should be understood that when an element such as a layer, film, region, or substrate is referred to as being "on" or "connected to" another element, the layer, film, region, or substrate may be directly on or connected to the another element or there may be an intermediate element. In contrast, when an element is referred to as being "directly on" or "directly connected to" another element, there is no intermediate element. As used herein, "connection" may refer to physical and/or electrical connection. Furthermore, for "electrical connection" or "coupling", there may be another element between two elements.

As used herein, "about", "approximately", or "substantially" includes a stated value and an average value within an acceptable range of deviation from a specific value determined by persons skilled in the art, considering specific amounts of the measurement in question and measurement-related errors (that is, the limitation of the measurement system). For example, "about" may mean within one or more standard deviations or within ±30%, ±20%, ±10%, or ±5% of the stated value. Furthermore, a more acceptable range of deviation or standard deviation may be selected for "about", "approximately", or "substantially" used herein according to optical properties, etching properties, or other properties, instead of using one standard deviation for all properties.

Unless otherwise defined, all terms (including technical and scientific terms) used herein have the same meaning as commonly understood by persons skilled in the art to which the disclosure belongs. It will be further understood that terms such as those defined in commonly used dictionaries should be interpreted as having meanings consistent with their meanings in related technologies and the context of the disclosure, and will not be interpreted as having idealized or overly formal meanings, unless explicitly defined herein.

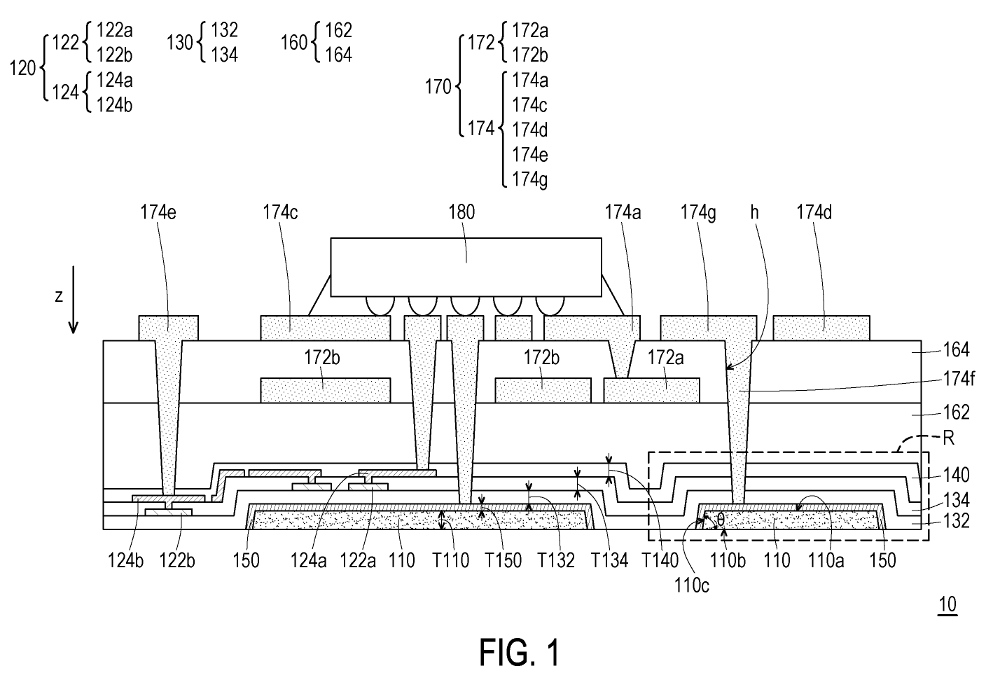

FIG. 1 is a schematic cross-sectional diagram of an antenna packaging structure according to an embodiment of the disclosure. Referring to FIG. 1, an antenna packaging structure 10 includes an electrode layer 110, a first circuit structure 120, and at least one inorganic dielectric layer 130. The first circuit structure 120 is disposed on the electrode layer 110 and includes a conductive layer 124. The at least one inorganic dielectric layer 130 is disposed between the conductive layer 124 of the first circuit structure 120 and the electrode layer 110. In some embodiments, the electrode layer 110 includes an antenna grounding electrode.

In some embodiments, the first circuit structure 120 may further include another conductive layer 122. The another conductive layer 122 is disposed on the electrode layer 110. The at least one inorganic dielectric layer 130 covers the another conductive layer 122. The conductive layer 124 is disposed on the at least one inorganic dielectric layer 130, and the at least one inorganic dielectric layer 130 is located between the conductive layer 124 and the another conductive layer 122. For example, in some embodiments, the conductive layer 122 may include a first portion 122a and a second portion 122b. The first portion 122a of the conductive layer 122 is electrically connected to the electrode layer 110, and the second portion 122b of the conductive layer 122 is separated from the first portion 122a of the conductive layer 122 and the electrode layer 110. The another conductive layer 124 may include a first portion 124a and a second portion 124b. The first portion 124a of the another conductive layer 124 is electrically connected to the first portion 122a of the conductive layer 122, and the second portion 124b of the another conductive layer 124 is electrically connected to the second portion 122b of the conductive layer 122 and is separated from the first portion 124a of the another conductive layer 124.

In some embodiments, the at least one inorganic dielectric layer 130 may selectively include a first inorganic dielectric layer 132 and a second inorganic dielectric layer 134 disposed on the first inorganic dielectric layer 132. That is, in some embodiments, the number of the inorganic dielectric layers 130 disposed between the conductive layer 124 of the first circuit structure 120 and the electrode layer 110 may selectively be 2. However, the disclosure is not limited thereto, and the number of the inorganic dielectric layers 130 disposed between the conductive layer 124 and the electrode layer 110 may also be other positive integers less than 2 or greater than 2. In some embodiments, the antenna packaging structure 10 may further include a third inorganic dielectric layer 140, disposed on the second inorganic dielectric layer 134 and covering the conductive layer 124 at the uppermost portion of the first circuit structure 120.

The electrode layer 110 has an upper surface 110a and a lower surface 110b opposite to each other and a side surface 110c. The upper surface 110a of the electrode layer 110 is located between the at least one inorganic dielectric layer 130 and the lower surface 110b of the electrode layer 110. The side surface 110c of the electrode layer 110 is connected to the upper surface 110a of the electrode layer 110 and the lower surface 110b of the electrode layer 110. In some embodiments, the antenna packaging structure 10 further includes a conductive connection layer 150, conformally covering the upper surface 110a and the side surface 110c of the electrode layer 110. The material of the conductive connection layer 150 is different from the material of the electrode layer 110. Furthermore, the adhesion between the material of the conductive connection layer 150 and the material of the inorganic dielectric layer 130 is greater than the adhesion between the material of the electrode layer 110 and the material of the inorganic dielectric layer 130. The conductive connection layer 150 may be used to strengthen the adhesion with the inorganic dielectric layer 130 and protect the electrode layer 110.

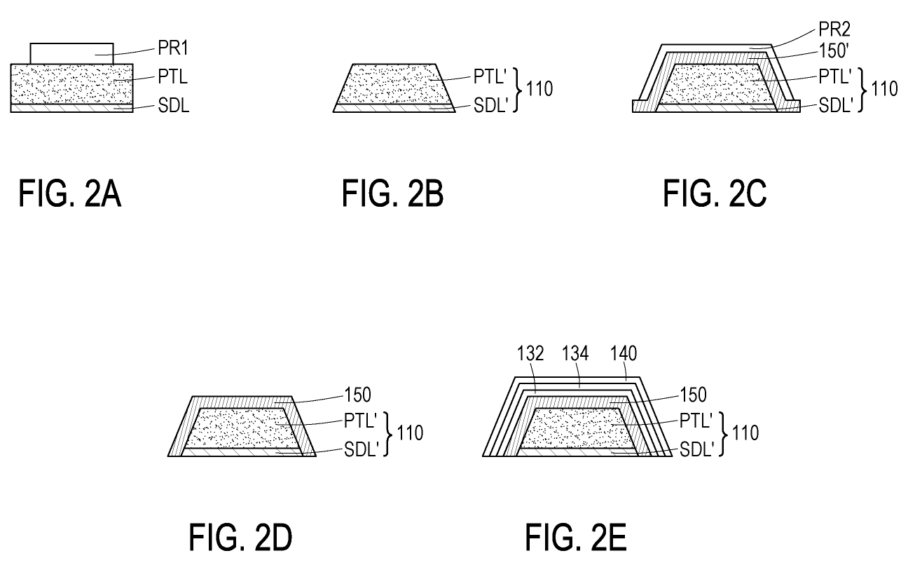

FIG. 2A to FIG. 2E are schematic cross-sectional diagrams of a partial manufacturing process of a portion of an antenna packaging structure according to an embodiment of the disclosure. FIG. 2A to FIG. 2E correspond to the portion R as shown in FIG. 1. The manufacturing process of the electrode layer 110, the conductive connection layer 150, the first inorganic dielectric layer 132, the second inorganic dielectric layer 134, and the third inorganic dielectric layer 140 before laser drilling is performed is illustrated below with reference to FIG. 2A to FIG. 2E.

Referring to FIG. 2A, in some embodiments, a seed layer SLD may be formed first, and then a plating layer PTL may be electroplated on the seed layer SLD. Referring to FIG. 2A and FIG. 2B, next, a first photoresist pattern PR1 is formed on the plating layer PTL, and then the seed layer SLD and the plating layer PTL are simultaneously patterned using the first photoresist pattern PR1 as a mask to form a seed pattern layer SLD' and a plating pattern layer PTL' that are stacked with each other and mutually aligned. The stacked structure of the seed pattern layer SLD' and the plating pattern layer PTL' may form the electrode layer 110. After forming the electrode layer 110, the first photoresist pattern PR1 may be removed.

Referring to FIG. 1 and FIG. 2B, an angle θ is included between the side surface 110c of the electrode layer 110 and the lower surface 110b of the electrode layer 110 within the material of the electrode layer 110. Since the electrode layer 110 is formed by patterning the seed layer SLD and the plating layer PTL using the first photoresist pattern PR1 as a mask, 0°<θ<90°. For example, in some embodiments, preferably, 40°≤θ≤60°, but the disclosure is not limited thereto. In some embodiments, the material of the electrode layer 110 includes, for example, copper, but the disclosure is not limited thereto.

Referring to FIG. 1 and FIG. 2C, next, a conductive connection material layer 150' is formed on the electrode layer 110. Referring to FIG. 1, FIG. 2C, and FIG. 2D, next, a second photoresist pattern PR2 is formed on the conductive connection material layer 150', and the conductive connection material layer 150' is patterned using the second photoresist pattern PR2 as a mask to form the conductive connection layer 150. Then, the second photoresist pattern PR2 is removed. In some embodiments, when viewed along the direction z perpendicular to the upper surface 110a of the electrode layer 110, it may be found that the shape of the conductive connection layer 150 is substantially the same as the shape of the electrode layer 110. Since the conductive connection layer 150 is formed by chemical vapor deposition and the electrode layer 110 is formed by electroplating, a thickness T150 of the conductive connection layer 150 may be smaller than a thickness T110 of the electrode layer 110. For example, in some embodiments, the material of the conductive connection layer 150 may include, for example, titanium, aluminum, indium, tin, or an oxide of at least one of titanium, aluminum, indium, tin. For example, in some embodiments, the thickness T150 of the conductive connection layer 150 may fall in the range of 0.02μm to 0.2μm, but the disclosure is not limited thereto.

Referring to FIG. 2D and FIG. 2E, next, a first inorganic dielectric layer 132, a second inorganic dielectric layer 134, and a third inorganic dielectric layer 140 are sequentially formed to cover the conductive connection layer 150 and the electrode layer 110. In some embodiments, the first inorganic dielectric layer 132, the second inorganic dielectric layer 134, and the third inorganic dielectric layer 140 may be formed using a Si-based chemical vapor deposition (CVD) process. In some embodiments, the material of the inorganic dielectric layer 130 and the material of the third inorganic dielectric layer 140 may include silicon-containing inorganic materials, for example but not limited to: silicon oxide, silicon nitride, silicon oxynitride, or a stacked layer of at least two of the above-mentioned materials. The first inorganic dielectric layer 132, the second inorganic dielectric layer 134, and the third inorganic dielectric layer 140 have thicknesses T132, T134, T140, respectively. For example, in some embodiments, each of the thicknesses T132, T134, T140 may fall in the range of 100nm to 1μm, but the disclosure is not limited thereto. In some embodiments, the sum of the thicknesses T132, T134, T140 may fall in the range of 1μm to 3μm, but the disclosure is not limited thereto.

Referring to FIG. 1, the antenna packaging structure 10 further includes at least one organic dielectric layer 160 and a second circuit structure 170. The electrode layer 110, the first circuit structure 120, and the at least one inorganic dielectric layer 130 are disposed on a lower side of the at least one organic dielectric layer 160. At least one portion 174g of the second circuit structure 170 is disposed on an upper side of the at least one organic dielectric layer 160. Specifically, in some embodiments, the at least one organic dielectric layer 160 may include a first organic dielectric layer 162 and a second organic dielectric layer 164, and the second circuit structure 170 may include a third conductive layer 172 and a fourth conductive layer 174. The first organic dielectric layer 162 is disposed on the third inorganic dielectric layer 140. The third conductive layer 172 of the second circuit structure 170 is disposed on the first organic dielectric layer 162. The second organic dielectric layer 164 is disposed on the first organic dielectric layer 162 and covers the third conductive layer 172. The fourth conductive layer 174 of the second circuit structure 170 is disposed on the second organic dielectric layer 164.

In some embodiments, the third conductive layer 172 of the second circuit structure 170 may selectively include a feed line 172a and a radio frequency grounding electrode 172b, and the fourth conductive layer 174 of the second circuit structure 170 may selectively include a radio frequency output electrode 174a, a radio frequency input electrode 174c, a power supply line 174d, and a pad 174e. The radio frequency output electrode 174a is electrically connected to the feed line 172a, and the pad 174e is electrically connected to the second portion 124b of the conductive layer 124 of the first circuit structure 120.

For example, in some embodiments, the material of the at least one organic dielectric layer 160 may include polyimide (PI), polyethylene naphthalate (PEN), polyethylene terephthalate (PET), polycarbonates (PC), polyether sulfone (PES), or polyarylate, or other suitable materials, or a combination of at least two of the above-mentioned materials, but the disclosure is not limited thereto.

Referring to FIG. 1, the antenna packaging structure 10 further includes a chip 180, disposed on an upper side of the at least one organic dielectric layer 160, and connected to at least one portion of the second circuit structure 170. For example, in some embodiments, the chip 180 is disposed on the fourth conductive layer 174 of the second circuit structure 170, and is at least connected to the radio frequency output electrode 174a and the radio frequency input electrode 174c of the fourth conductive layer 174.

In the process of the antenna packaging structure 10, after forming the inorganic dielectric layer 130, the third inorganic dielectric layer 140, and the organic dielectric layer 160, a laser drilling process may be simultaneously performed on the inorganic dielectric layer 130, the third inorganic dielectric layer 140, and the organic dielectric layer 160 to form a hole h. Then, the fourth conductive layer 174 of the second circuit structure 170 may be formed on the organic dielectric layer 160, where a portion of the fourth conductive layer 174 is filled into the hole h to form a conductive via 174f. The conductive via 174f is disposed in the organic dielectric layer 160, the inorganic dielectric layer 130, and the third inorganic dielectric layer 140, and electrically connects a portion 174g of the second circuit structure 170 and the electrode layer 110. In particular, the conductive via 174f is integrally formed.

It is worth mentioning that since the angle θ of the electrode layer 110 is an acute angle, the dielectric layer formed on the electrode layer 110 may use a thinner inorganic dielectric layer 130, so that the inorganic dielectric layer 130 is capable of filling the gap between the side surface 110c of the electrode layer 110 and the underlying substrate (not shown). Since the dielectric layer disposed between the electrode layer 110 and the organic dielectric layer 160 is the inorganic dielectric layer 130, when using a desmear process to clean the inside of the hole h, the desmear solution does not easily damage the dielectric layer (i.e., the inorganic dielectric layer 130) between the electrode layer 110 and the organic dielectric layer 160. In addition, the inorganic dielectric layer 130 also has the effects of reducing stress, reducing warpage, and blocking moisture. For example, the warpage of a conventional antenna packaging structure is 1mm, while the warpage of the antenna packaging structure 10 of the embodiment may be reduced to 0.5mm.

Furthermore, in some embodiments, in the process of the antenna packaging structure 10, a laser drilling process may be simultaneously performed on the inorganic dielectric layer 130 and the organic dielectric layer 160 to form a hole h, and then the fourth conductive layer 174 may be formed in a single step to be electrically connected to the electrode layer 110 through the continuous conductive via 174f, such that it is not necessary to form multiple conductive layers in segments to achieve electrical connection to the electrode layer 110. Consequently, the number of masks used and the number of conductive layers fabricated may be reduced, such that the process of the antenna packaging structure 10 is simplified.

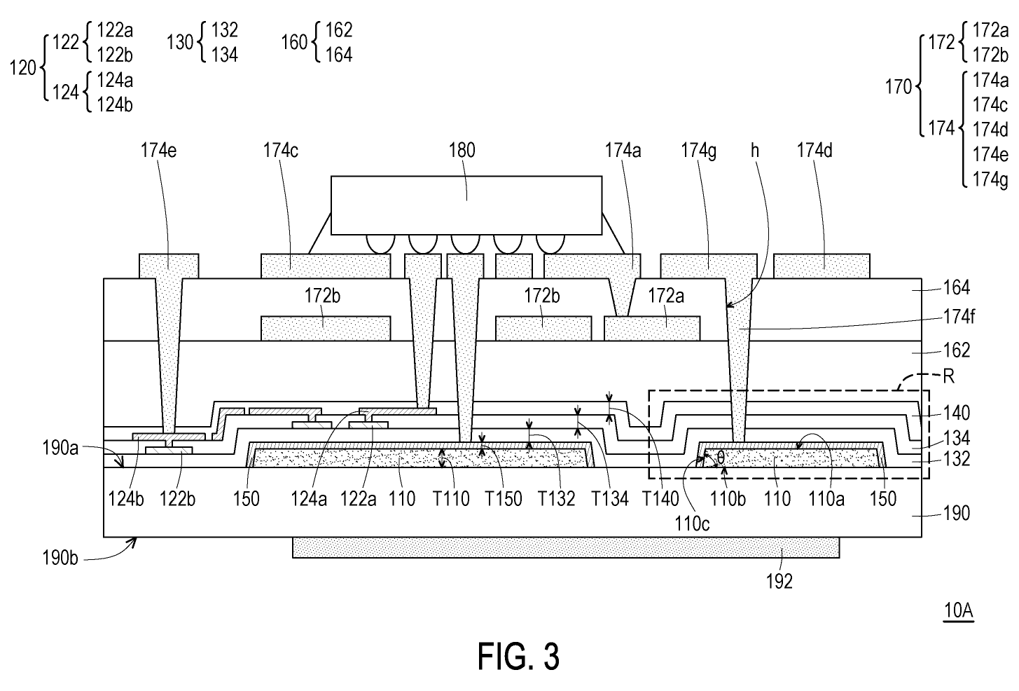

FIG. 3 is a schematic cross-sectional diagram of an antenna packaging structure according to another embodiment of the disclosure. Referring to FIG. 1 and FIG. 3, the antenna packaging structure 10A of FIG. 3 is similar to the antenna packaging structure 10 of FIG. 1. The difference between the antenna packaging structure 10A of FIG. 3 and the antenna packaging structure 10 of FIG. 1 is that the antenna packaging structure 10A of FIG. 3 further includes a first substrate 190 and a first antenna patch 192. The first substrate 190 has a first surface 190a and a second surface 190b opposites to each other. The electrode layer 110 is disposed on the first surface 190a of the first substrate 190, and the first antenna patch 192 is disposed on the second surface 190b of the first substrate 190. The first antenna patch 192 is overlapped with the electrode layer 110. In some embodiments, a material of the first substrate 190 may include glass, but the disclosure is not limited thereto.

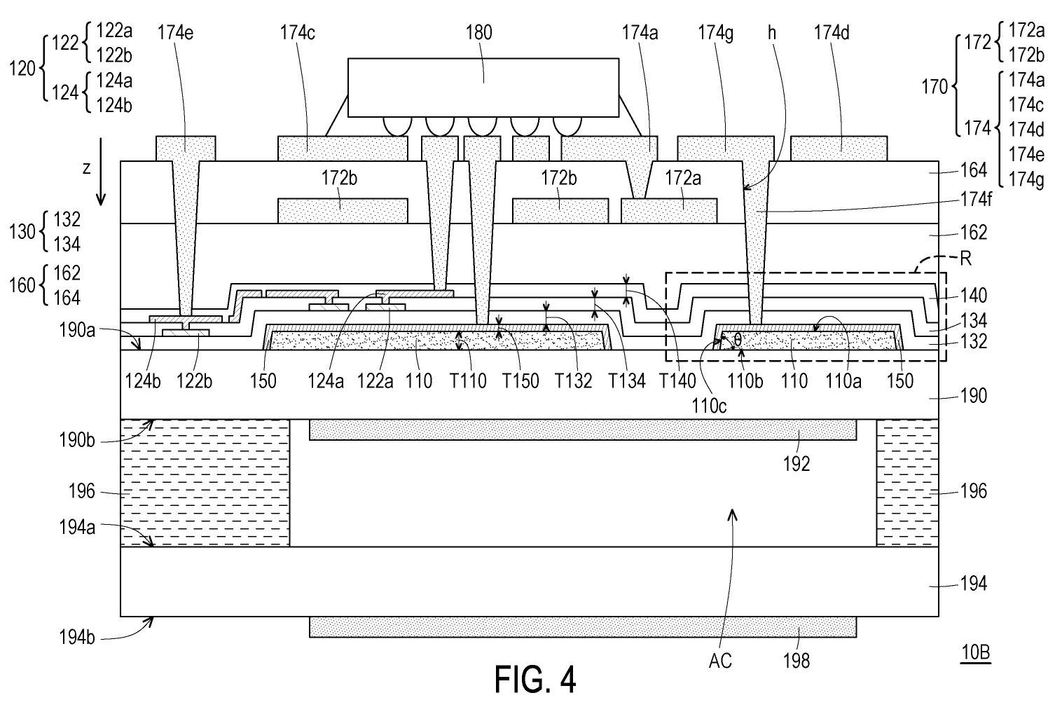

FIG. 4 is a schematic cross-sectional diagram of an antenna packaging structure according to another one embodiment of the disclosure. Referring to FIG. 3 and FIG. 4, the antenna packaging structure 10B of FIG. 4 is similar to the antenna packaging structure 10A of FIG. 3. The difference between the antenna packaging structure 10B of FIG. 4 and the antenna packaging structure 10A of FIG. 3 is that the antenna packaging structure 10B of FIG. 4 further includes a second substrate 194, a support 196 and a second antenna patch 198. The second substrate 194 is disposed opposites to the first substrate 190, wherein the first substrate 190 is located between the electrode layer 190 and the second substrate 194. The support 196 is disposed between the first substrate 190 and the second substrate 194. A cavity AC is surrounded by the support 196, the first substrate 190 and the second substrate 194. The second substrate 194 has a first surface 194a and a second surface 194b, wherein the first surface 194a of the second substrate 194 faces the first substrate 190, and the second surface 194b of the second substrate 194 faces away from the first substrate 190. The second antenna patch 198 is disposed on the second surface 194b of the second substrate 194. In some embodiments, a material of the second substrate 194 may include glass, but the disclosure is not limited thereto.

What is claimed is:

1. An antenna packaging structure, comprising:
an electrode layer;
a first circuit structure, disposed on the electrode layer, and comprising a conductive layer;
at least one inorganic dielectric layer, disposed between the conductive layer of the first circuit structure and the electrode layer;
at least one organic dielectric layer, wherein the electrode layer, the first circuit structure, and the at least one inorganic dielectric layer are disposed on a lower side of the at least one organic dielectric layer;
a second circuit structure, wherein at least one portion of the second circuit structure is disposed on an upper side of the at least one organic dielectric layer; and
a chip, disposed on the upper side of the at least one organic dielectric layer, and connected to the at least one portion of the second circuit structure;
wherein the electrode layer has an upper surface and a lower surface opposite to each other and a side surface, the upper surface of the electrode layer is located between the at least one inorganic dielectric layer and the lower surface of the electrode layer, the side surface of the electrode layer is connected to the upper surface of the electrode layer and the lower surface of the electrode layer, an angle θ is included between the side surface of the electrode layer and the lower surface of the electrode layer within a material of the electrode layer, and 0°<θ<90°.

2. The antenna packaging structure according to claim 1, wherein 40°≤θ≤60°.

3. The antenna packaging structure according to claim 1, further comprising:
a conductive connection layer, conformally covering the upper surface and the side surface of the electrode layer, wherein a material of the conductive connection layer is different from a material of the electrode layer.

4. The antenna packaging structure according to claim 3, wherein an adhesion between the material of the conductive connection layer and a material of the at least one inorganic dielectric layer is greater than an adhesion between the material of the electrode layer and the material of the at least one inorganic dielectric layer.

5. The antenna packaging structure according to claim 3, wherein the material of the electrode layer comprises copper, a material of the at least one inorganic dielectric layer comprises silicon-containing inorganic material, and the material of the conductive connection layer comprises titanium, aluminum, indium, tin, or an oxide of at least one of titanium, aluminum, indium, tin.

6. The antenna packaging structure according to claim 3, wherein a shape of the conductive connection layer is substantially the same as a shape of the electrode layer.

7. The antenna packaging structure according to claim 1, further comprising:
a conductive via, disposed in the at least one organic dielectric layer and the at least one inorganic dielectric layer, and electrically connecting a portion of the second circuit structure and the electrode layer, wherein the conductive via is integrally formed.

8. The antenna packaging structure according to claim 1, wherein the first circuit structure further comprises:
another conductive layer, disposed on the electrode layer, wherein the at least one inorganic dielectric layer covers the another conductive layer, the conductive layer is disposed on the at least one inorganic dielectric layer, and the at least one inorganic dielectric layer is located between the conductive layer and the another conductive layer.

9. The antenna packaging structure according to claim 8, wherein the conductive layer comprises a first portion and a second portion, the first portion of the conductive layer is electrically connected to the electrode layer, and the second portion of the conductive layer is separated from the first portion of the conductive layer and the electrode layer.

10. The antenna packaging structure according to claim 9, wherein the another conductive layer comprises a first portion and a second portion, the first portion of the another conductive layer is electrically connected to the first portion of the conductive layer, and the second portion of the another conductive layer is electrically connected to the second portion of the conductive layer and separated from the first portion of the another conductive layer.

11. The antenna packaging structure according to claim 1, further comprising:
a first substrate having a first surface and a second surface opposites to each other, wherein the electrode layer is disposed on the first surface of the first substrate; and
a first antenna patch, disposed on the second surface of the first substrate, wherein the first antenna patch is overlapped with the electrode layer.

12. The antenna packaging structure according to claim 11, further comprising:
a second substrate disposed opposites to the first substrate, wherein the first substrate is located between the electrode layer and the second substrate, the second substrate has a first surface and a second surface, the first surface of the second substrate faces the first substrate, and the second surface of the second substrate faces away from the first substrate;
a support disposed between the first substrate and the second substrate, wherein a cavity is surrounded by the support, the first substrate and the second substrate; and
a second antenna patch disposed on the second surface of the second substrate.

13. An antenna packaging structure, comprising:
an electrode layer;
a first circuit structure, disposed on the electrode layer, and comprising a conductive layer;
at least one inorganic dielectric layer, disposed between the conductive layer of the first circuit structure and the electrode layer;
at least one organic dielectric layer, wherein the electrode layer, the first circuit structure, and the at least one inorganic dielectric layer are disposed on a lower side of the at least one organic dielectric layer;
a second circuit structure, wherein at least one portion of the second circuit structure is disposed on an upper side of the at least one organic dielectric layer;
a chip, disposed on the upper side of the at least one organic dielectric layer, and connected to the at least one portion of the second circuit structure; and
a conductive connection layer, conformally covering the electrode layer, wherein a material of the conductive connection layer is different from a material of the electrode layer.

14. The antenna packaging structure according to claim 13, wherein an adhesion between the material of the conductive connection layer and a material of the at least one inorganic dielectric layer is greater than an adhesion between the material of the electrode layer and the material of the at least one inorganic dielectric layer.

15. The antenna packaging structure according to claim 14, wherein the material of the electrode layer comprises copper, the material of the at least one inorganic dielectric layer comprises silicon-containing inorganic material, and the material of the conductive connection layer comprises titanium, aluminum, indium, tin, or an oxide of at least one of titanium, aluminum, indium, tin.

16. The antenna packaging structure according to claim 13, wherein a shape of the conductive connection layer is substantially the same as a shape of the electrode layer.

17. The antenna packaging structure according to claim 13, further comprising:
a conductive via, disposed in the at least one organic dielectric layer and the at least one inorganic dielectric layer, and electrically connecting a portion of the second circuit structure and the electrode layer, wherein the conductive via is integrally formed.

18. The antenna packaging structure according to claim 13, further comprising:
a first substrate having a first surface and a second surface opposites to each other, wherein the electrode layer is disposed on the first surface of the first substrate; and
a first antenna patch, disposed on the second surface of the first substrate, wherein the first antenna patch is overlapped with the electrode layer.

19. The antenna packaging structure according to claim 18, further comprising:
a second substrate disposed opposites to the first substrate, wherein the first substrate is located between the electrode layer and the second substrate, the second substrate has a first surface and a second surface, the first surface of the second substrate faces the first substrate, and the second surface of the second substrate faces away from the first substrate;
a support disposed between the first substrate and the second substrate, wherein a cavity is surrounded by the support, the first substrate and the second substrate; and
a second antenna patch disposed on the second surface of the second substrate.
